(19) United States
(12) Patent Application Publication
(10) Pub. No.: US 2016/0374364 A1
(43) Pub. Date: Dec. 29, 2016

(54) METHOD OF AND SYSTEM FOR PRODUCING A HIGH VALUE ANIMAL FEED ADDITIVE FROM A STILLAGE IN AN ALCOHOL PRODUCTION PROCESS

(71) Applicant: Lee Tech LLC., San Jose, CA (US)

(72) Inventor: Chie Ying Lee, San Jose, CA (US)

(21) Appl. No.: 15/187,702

(22) Filed: Jun. 20, 2016

Related U.S. Application Data
(60) Provisional application No. 62/184,768, filed on Jun. 25, 2015.

(51) Int. Cl. A23K 10/12; A23K 10/38; A23N 17/00; A23K 10/18

(52) U.S. Cl. CPC A23K 10/12; A23K 10/18; A23K 10/38; A23N 17/001

(57) ABSTRACT

A method of and a system for controlling the culture growth of high value feed organisms in a co-fermented system that produces ethanol and for the culture to consume both nonprotein and carbohydrate based products. The method and system produce products that enhance the nutritional value of the co-products. The method further provides a system to grow unique value added co-products, including a mycotoxin-free animal feed, for the monogastric and ruminant animal feed markets including aquaculture, poultry, swine, companion animals and livestock animals. The method includes the production of organic acids to enrich animal feed for enhanced animal performance with reduced antibiotic components in the feed. The method includes the production and incorporation of probiotics in the animal feed product.

### CROSS-REFERENCE TO RELATED APPLICATION(S)

This application claims priority under 35 U.S.C. §119(e) of the U.S. Provisional Patent Application Ser. No. 62/184,768, filed Jun. 25, 2015 and titled, “A Method of and System for Producing a High Value Animal Feed Additive from a Stillage in an Alcohol Production Process,” which is also hereby incorporated by reference in its entirety for all purposes.

### FIELD OF THE INVENTION

The present invention relates to the field of animal feed production. More specifically, the present invention relates to animal feed production with an enhanced nutritional value.

### BACKGROUND OF THE INVENTION

FIG. 1 illustrates a typical wet mill process for alcohol production. FIG. 2 illustrates a typical dry mill process with a backend oil recovery system. FIG. 3 illustrates a typical dry mill process with a backend oil and protein recovery system. FIG. 4 illustrates a typical dry mill process with a front grind milling and front oil recovery system. FIG. 5 illustrates a typical dry mill process with a front grind milling, front oil recovery, and front de-fiber system. FIG. 6 illustrates a typical dry mill process with a back end grind and a backend oil recovery system.

The conventional methods of producing alcohols from grains generally follow similar procedures depending on whether the process is operated in a wet mill or dry grind facility. Wet mill corn processing plants convert corn grain into several different co-products, such as germ (for oil extraction), gluten feed (high fiber animal feed), gluten meal (high protein animal feed), and starch-based products such as ethanol, high fructose corn syrup, or food and industrial starch. Dry grind ethanol plants convert corn into two products, namely ethanol and distiller's grains with soluble. If the products are sold as wet animal feed, distiller's wet grains with soluble is referred to as DWGS. If the products are sold dried as an animal feed, distiller's dried grains with soluble is referred to as DDGS. In the standard dry grind ethanol process, one bushel of corn yields approximately 8.2 kg (approximately 17 lbs.) of DDGS in addition to the approximately 10.3 liters (approximately 2.75 gal) of ethanol. These co-products provide a critical secondary revenue stream that offsets a portion of the overall ethanol production costs.

Generally, DDGS is sold as a low value animal feed even though the DDGS contains 10-13% of oil and 28-33% of protein. Some plants have modified the typical dry mill process to separate the valuable oil and protein from the DDGS. There are about 100 plants with a backend oil recovery system having a process (as shown in FIG. 2) disclosed in the U.S. Pat. No. 7,601,858, one plant uses a protein recovery system having a process (as shown in FIG. 3) disclosed in the PCT/US09/45163 (titled “METHODS FOR PRODUCING A HIGH PROTEIN CORN MEAL FROM A WHOLE STILLAGE BYPRODUCT AND SYSTEM THEREFORE”), and twenty five plants use a front grinding mill to increase alcohol yield that uses a process (see FIG. 4) disclosed in the PCT/US12/30337 (titled “DRY GRIND ETHANOL PRODUCTION PROCESS AND SYSTEM WITH FRONT END MILLING METHOD,” which are incorporated by reference in their entirety for all purposes. These plants are modified to increase an alcohol yield of the plants and to recover valuable oil in the front end. There are also four plants recovering a high fiber fraction from the cooked mash allowing the production of high protein distiller's and higher oil recoveries (see FIG. 5).

The typical wet milling and dry milling processes possess common fermentation processes. This type of fermentation to produce an agricultural alcohol utilizes and converts the starch based carbohydrates found in grains and converts those to glucose using well known enzymatic processes. Saccharomyces cerevisiae (yeast) converts the glucose molecule to ethanol and carbon dioxide along with other products including glycerol and yeast bodies. The ethanol is removed from the fermentation broth with conventional steam distillation and sold as a valuable transportation fuel and industrial alcohol. The method for producing grain based agricultural alcohol using one fermentation follows a well known method using either batch or continuous fermentation. What remains after starch conversion and fermentation are different depending on the processes used. As shown in FIG. 1 (a wet mill process), the material remaining after alcohol recovery is spent yeast, non-volatile yeast metabolites and soluble solids from grain. As shown in FIG. 2 (a typical simple dry mill process), the material remaining after alcohol recovery is a mixture of spent grains containing proteins, fiber, yeast, oil, yeast metabolites, non-fermentable sugars, non-fermented sugars, organic acids, minerals and other constituents. After ethanol recovery, these remnants are in a semi liquid form, which is called whole stillage. The whole stillage is separated by centrifugation into a wet solid, which is called wet distiller's grains (mainly fiber and protein), and liquid, which is called thin stillage (containing mainly oil, yeast bodies, soluble compounds, and fine suspended grain particles).

This thin stillage normally goes to an evaporator system to be concentrated to contain 30 to 50% dry solids (70 to 50% water) which is called syrup. Optional processes can recover oil from the syrup as a separate product, which is shown in the FIG. 2. In a typical dry mill plant, the centrifuge solids (WDG) and syrup are mixed together and are dried to produce DDGS, which are sold into the animal feed markets for both ruminant and monogastric animals throughout the world. The DDGS generally has more than 30% of protein. However, because the high concentration of fiber, it is not suitable as a high inclusion product for chicken and fish diets.

Many processes have been developed to improve the value and the usage of DDGS. In the FIG. 3, the protein is removed/recovered from DDG. In FIG. 4, the front grinding is added to the front end to improve the oil and protein recovery. In FIG. 5, the fiber can be separated before fermenter. These processes allow what used to be sold as DDGS to be separated into four portions: a) fiber, b) protein, c) syrup, and d) oil. The process illustrated in the FIG. 6 is similar to the process of FIG. 5, except that the grinding step and the fiber removing/recovering step is at the backend instead of at the front end.

Generally, all wet mill and dry mill processes produce syrup at the end of the processes. The syrup contains the soluble minerals from grains and has “unidentified growth factors.” The unidentified growth factors are nutrient ingredients, such as vitamin, which are from yeast in the fermentation step.

The thin stillage normally contains 5 to 8% of solids (95 to 92% water) and is processed through an evaporator system, such that the stillage is subsequently concentrated to contain 30 to 50% of solids (70 to 50% water) before the stillage is mixed with a wet cake from the centrifuge (WDG) to produce low cost DDGS. DDGS is mainly used for ruminant animal feed because of its high fiber content and mycotoxin concentration.

Significant research and development work have been done in improving the value of the thin stillage, including increasing the protein content by using an aerobic fermentation. The thin stillage from the ethanol production contains biodegradable organic compounds and sufficient micronutrients for fungal cultivation, such as Rhizopus microsporus variant oligosporus. The fungus removes about 60% of the organic material, including the suspended solids and even more of some specific substances that are undesirable for recycling. Then, the fungal pellets can easily be harvested as a food-grade organism (RO), which is rich in fat and protein (specifically the amino acids, such as lysine and methionine). However, the cost of the whole system and amount of energy that are needed for this system is high and cannot be justified on a commercial scale. Also, a USDA approval is required for the fungus before the system can be in a commercial operation.

### SUMMARY OF THE INVENTION

In some cases, various species of yeast that are capable of synthesizing one or more predetermined nutrients, especially carotenoids, are added to an organic feed material. The feed material and yeast are fermented, which result in the yeast synthesizing the predetermined nutrients. The fermentation mixture can then be dried or otherwise processed into an animal feed product that contains the nutrients synthesized during the fermentation process. In some cases, the secondary fermentation takes up to 5 days to produce natural Carotenoids from the whole stillage.

In some other cases, recycling yeast on a batch fermentation system of a dry mill process is used to reduce the fermentation time around 10 hours and the microorganism inside the corn grows slowly by using a recycling set up system, which produces lactic acid toward the end of fermentation. In this case, the lactic acid changes from normally less than 0.2% to more than 1% after a four batch recycling operation. The percentage of the alcohol yield increases with a recycling setup even the percentage of the lactic acid is as high as 1% or more. This microorganism can produce lactic acid with DP4 (tetrasaccharide) or other carbohydrate, such as glycerol without glucose.

In some embodiments, pathways/methods of making value added products are provided, including lactic acid (e.g., using grains), enzymes, yeast(s) and bacteria to create value added products. Grains of all sorts can be used for grain based ethanol. Maize (corn) is able to be a feedstock. Corn grown throughout the world is susceptible to mycotoxin contamination during its growing season. These mycotoxins are produced by natural molds in the soil, which grow on the surface of the kernel along the growing and maturing processes of the corns. Some weather conditions during the late growth and maturation of the crop play a key role in mycotoxin generation. In addition, some storage conditions of the grain can also generate mycotoxins. Mycotoxins on grain and other animal feed products create severe digestive problems for animals of all kinds limiting weight gain and animal health in general.

These mycotoxins are on the surface of the kernel of corn as the corns enter the processing facility. The mycotoxins pass through the ethanol production process intact. Further, the mass reduction at the fermentation process results in a three fold increase in the original concentration of the mycotoxins in the DDGS. This three fold increase in concentration is a major problem for the processing facilities. With the increased concentration of the mycotoxins, the animal feed products generated at the ethanol facility become more toxic to the animals. The animal feeds produced at these facilities are a very important part of the economic model, which is used to subside the operational costs. However, high concentrations of mycotoxins limit the sales locations for these grains and reduce the market price paid for the feed.

Many studies have shown the benefits of a high protein, low carbohydrate feed. The use of this material in feed rations greatly enhances the nutritional value for animals of all kinds Mycotoxin contaminated animal feed forces the producer to heavily discount their products or pay a premium for mycotoxin free corn feedstock.

Various embodiments described herein provide a method to remove the mycotoxins from the corn grain prior to processing. The methods disclosed herein significantly reduce the concentrating effects of mycotoxins in the animal feeds, which are produced at a corn based ethanol plant. The mycotoxin free animal feeds produced from the processes can now be fed to animals without concerning about the negative health effects associated with mycotoxins.

, the process described herein produces a low insoluble, low fiber, nutritive soluble stream, which is able to be a suitable feed for young animals. This soluble stream contains a mixture of corn and yeast components, which are highly digestible and perfectly suited for baby animals. This stream contains a mixture of amino acids, minerals and yeast components. The mixture is able to be used to make animal feed, which contains many highly digestible nutrients along with useful concentrations of unidentified growth factor(s).

Unidentified growth factor(s) can be a term used to describe the numerous benefits of this soluble stream. The enhanced soluble stream has the ability to be concentrated to contain 80% of solids (20% water), which increases both it's shelf life by limiting growth of organisms in the syrup (due to low water activity) and lower transportation costs (due to the low amount of water present when compared to a traditionally processed syrup).

Baby swine and aquaculture feeding systems are able to use this highly nutritive soluble stream to enhance weight gain and encourage both aquatic fish and algae growth. The algae becomes excellent feed in itself for the larger organisms in the aquaculture system, namely fish, crustaceans, and shrimp. The algae growth that contains proteins, fibers, fats and minerals enhances the entire aquaculture ecosystem.

Moreover, beneficial microorganisms have been proven to improve general health in livestock. Probiotics are able to be used to compete with pathogens for nutrition and environment. In some embodiments, probiotics are used to release compounds that are toxic to pathogens, which stimulates immune system in gastrointestinal area, result in higher growth performance, higher digestibility, and stronger immunity of the animals. In some embodiments, organic acids are used as a feed additive to increase intake and prevent contamination by salmonella and mastitis. In some embodiments, continuous intake of organic acids and living probiotics are used, which play an important role in the continuing supply in the animal feed ration.

Generally, the whole stillage is produced as a liquid byproduct from an ethanol fermentation using yeasts. The thin stillage is produced after protein and fiber removal by centrifugation. The syrup is a concentrate of the thin stillage after the removal of water by evaporation. The thin stillage and syrup contain protein, fat, minerals, amino acid, yeast metabolites, fiber, monosaccharides, disaccharides, oligosaccharides, potassium, phosphorus and other unidentified growth factors. It is beneficial to use the thin stillage as a substitute animal feed, due to its low cost and high nutritional value.

Thin stillage is ideal for culturing microorganisms due to its nutritional content. Ideal probiotics have been selected to maximize lactic acid concentration in both syrup and in the thin stillage. The isolate converts carbohydrates and other components to lactic acid in syrup and serves as probiotics when fed to livestock. Once the isolate has been picked and identified, it can also be a genetically engineered host to produce aflatoxin degrading enzyme found from other bacteria. In this way, the isolate can produce lactic acid and degrade aflatoxin during one fermentation step.

Bacteria, demonstrating cellulase and hemicellulose activity, are able to be introduced prior to or with bacteria isolate for a co-fermentation process to break cellulose and hemicellulose down to monosaccharides or disaccharides, which are able to be accessible carbon sources for lactic acid producing bacteria, such that the lactic acid productivity is able to be maximized.

Further, bacteria, demonstrating protease activity, can be introduced after cellulase treatment. The bacteria are used to breakdown protein and peptide chains into smaller molecules including the amino acids. The smaller amino acid molecules are more accessible to animals that have less efficient digestive systems. For example, chicken is a typical example animal with poor digestibility with only 50% of supplied nutrients from DDGS absorbed during digestion.

In some embodiments because of high potassium and phosphorus content, the end products are also suitable for culturing algae, which are valuable products in the fish market. Organic acid and probiotics are beneficial to fish similar to other ground animals. In some embodiments, the high-end nutrient products are fed to fish directly or specifically to algae-eating fish after cultured. In some embodiments, the high-end nutrient products are combined with algae to be fed to the fish.

In an aspect, a method of producing a nutrient added animal feed comprises cleaning a feedstock until a majority of mycotoxin on a surface of the feedstock are removed, milling the feedstock to form a milled feedstock, liquefying the milled feedstock to form a liquefied feedstock, performing a first fermenting of the liquefied feedstock, adding new culture to a second fermenting, and forming the nutrient added animal feed.

In some embodiments, the cleaning comprises washing using water. In other embodiments, the feedstock comprises corns. In some other embodiments, the second fermenting grows microorganisms that generates the nutrient. In some embodiments, the nutrient comprises lactic acid, carotenoids, antioxidants, or a combination thereof In other embodiments, the new culture is added to a beer well. In some other embodiments, the second fermenting in the beer well is after the first fermenting and before distilling. In some embodiments, the new culture is added to a thin stillage. In other embodiments, the adding new culture is after distilling. In other embodiments, the adding new culture is before evaporating and after removing fiber and protein. In some other embodiments, the new culture is added to a semi-concentrated syrup in a holding tank. In some embodiments, the second fermenting occurs during an evaporating. In some embodiments, the second fermenting occurs before an evaporating. In some embodiments, the second fermenting occurs after an evaporating.

In another aspect, a nutrient added animal feed producing system comprises a corn washing device configured to remove a majority of mycotoxin on a surface of corns, a milling device configured to convert the corns to milled corns, a liquefying tank configured to convert the milled corns to form a liquefied substance, a first fermenting tank configured to perform a first fermentation, such that the liquefied substance becomes a first fermented substance, and a second fermenting tank configured to receive a new culture and perform a second fermentation.

In some embodiments, the second fermentation grows microorganisms that generates the nutrient. In other embodiments, the nutrient comprises lactic acid, carotenoids, antioxidants, or a combination thereof. In some other embodiments, the new culture is added to a beer well. In some embodiments, the second fermentation in the beer well is after the first fermentation and before distillation. In other embodiments, the new culture is added to a thin stillage. In some other embodiments, the new culture is added after distilling. In some other embodiments, the new culture is added before evaporator and after a fiber and protein removal device. In some embodiments, the new culture is added to a semi-concentrated syrup in a holding tank. In other embodiments, the second fermentation is in an evaporator. In some embodiments, the second fermenting occurs before an evaporating. In some embodiments, the second fermenting occurs after an evaporating.

In another aspect, a method of producing a nutrient added animal feed comprises milling corns to form a milled corns, liquefying the milled corns to form a liquefied substance, performing a first fermenting of the liquefied substance, performing a second fermenting, and forming the nutrient added animal feed.

In some embodiments, the method further comprises adding a new culture. In other embodiments, the new culture is added to the second fermenting. In some other embodiments, the second fermenting is after the first fermenting and before distilling. In some embodiments, the second fermenting is after fiber and protein separating and distilling. In other embodiments, the second fermenting is in a thin stillage tank. In some other embodiments, the second fermenting is in a semi-concentrated syrup tank.

In an aspect, a method of producing a nutrient added animal feed comprises performing a first fermentation and generating organic acid, probiotics, or both in a second fermentation. In some embodiments, the method further comprises adding microorganisms to the second fermentation. In other embodiments, the microorganisms comprise Lactobacillus spp., Bifidobacterium spp., Streptococcus spp., or a combination thereof In some other embodiments, the microorganisms comprise Bacillus spp., Enterococcus spp., or a combination thereof. In some embodiments, the microorganisms produce proteases breaking the emulsion to improve oil recovery. In some embodiments, the microorganisms comprise Bacillus fastidiosus, Aspergillus funiculosus, or a combination thereof In other embodiments, the method further comprises providing an environment suitable for a growth of probiotic microorganisms. In some other embodiments, the organic acid comprises lactic acid or acetic acid. In some embodiments, the method further comprises growing probiotics using a liquid ferment from the first fermentation as a culture. In some embodiments, the first fermentation is performed in series before the second fermentation, wherein the first fermentation comprises a first type or amount of microorganism different from a second type or amount of microorganism in the second fermentation

In another aspect, a method of producing a nutrient added animal feed comprises performing a first fermentation, adding microorganisms to a second fermentation, and producing probiotic animal feed. In some embodiments, the first fermentation comprises a fermentation step for alcohol production. In other embodiments, the second fermentation is at a beer well. In some other embodiments, the beer well is after the first fermentation and before distilling. In some embodiments, the second fermentation is at a thin stillage. In other embodiments, the thin stillage is after separating fiber and protein. In some other embodiments, the second fermentation is at a whole stillage after distilling. In some embodiments, the second fermentation is at a semi-concentrated syrup tank. In some other embodiments, the second fermentation is performed during a multi-stage evaporating. In some embodiments, the second fermentation is before oil separating. In some other embodiments, the second fermentation is after oil separating. In some embodiments, the second fermentation is after evaporating. In some other embodiments, the second fermentation comprises protein, fat, minerals, amino acid, yeast metabolites, fiber, monosaccharides, disaccharides, oligosaccharides, potassium, phosphorus, or growth factors.

In another aspect, a system for making probiotic animal feed comprises a first fermenter for making alcohol and a second fermenter with added microorganisms coupled with the first fermenter. In some embodiments, the second fermenter is at a beer well. In other embodiments, the beer well is after the first fermenter and before distiller. In some other embodiments, the second fermenter is at a thin stillage tank. In some embodiments, the thin stillage is after a fiber and protein recovery device. In some other embodiments, the second fermenter comprises a whole stillage after distiller. In some embodiments, the second fermenter is at a semi-concentrated syrup tank. In some other embodiments, the second fermenter is before an oil recovering device. In some embodiments, the second fermenter is before an oil recovering device. In other embodiments, the second fermentation is after evaporator.

In an aspect, a method of producing a nutrient added animal feed comprises removing aflatoxins from incoming corn with a water wash system before a hammer mill, performing a first fermentation, and generating probiotics, antioxidants, carotenoids, amino acids or a combination thereof in a second fermentation.

In some embodiments, the method further comprises adding microorganisms to the second fermentation. In other embodiments, the microorganisms comprise Bifidobacterium spp., Streptococcus spp., Bacillus spp., or a combination thereof. In some other embodiments, the microorganisms comprise Bacillus spp., Enterococcus spp., or a combination thereof. In some embodiments, the microorganisms produces proteases breaking emulsion to improve oil recovery. In some embodiments, the microorganisms comprise Bacillus fastidiosus, Aspergillus funiculosus, or a combination thereof In other embodiments, the method of claim 34, further comprising providing an environment suitable for a growth of probiotic microorganisms. In some other embodiments, the organic acid comprises lactic acid or acetic acid. In some embodiments, the method further comprises growing probiotics using a liquid ferment from the first fermentation as a culture.

In another aspect, a system for making probiotic animal feed with low aflatoxin concentration comprises washing aflatoxins out of incoming corn with a water wash system before the hammer mill, a first fermenter for making alcohol, a second fermenter with added microorganisms coupled with the first fermenter.

In some embodiments, the second fermenter is at a beer well. In other embodiments, the beer well is after the first fermenter and before distillation. In some other embodiments, the second fermenter is performed in the thin stillage tank. In some embodiments, the thin stillage is after a fiber and protein recovery device. In other embodiments, the second fermenter system comprises fermenting after distillation. In some other embodiments, the second fermenter is at a concentrated syrup or semi-concentrated syrup tank. In some embodiments, the second fermenter is before an oil recovering device. In other embodiments, the second fermenter is after an oil recovering device. In some other embodiments, the second fermentation is after evaporation.

In another aspect, a method of producing a nutrient added animal feed comprises performing a first fermentation for producing an alcohol, taking microorganisms at an end of first fermentation, and adding the microorganisms in a second fermentation after distillation to propagate and produce organic acid, probiotic or a combination thereof. In some embodiments, the second fermentation comprises a fermenter having a whole stillage tank after a distilling device. In other embodiments, the second fermentation comprises a fermenter having a thin stillage tank after separating fiber and protein. In some other embodiments, the second fermentation comprises a fermenter having a semi-concentrate syrup tank during a process of multi stage evaporating. In some other embodiments, the second fermentation comprises a fermenter having a syrup tank after evaporating. In some embodiments, the method further comprises adding the microorganisms as a culture to the second fermentation. In some embodiments, the method further comprises providing an environment suitable for a growth of probiotic microorganisms. In other embodiments, the method further comprises providing an environment suitable for a growth of a type of microorganism, which breaks down a mycotoxin in the secondary fermentation. In some other embodiments, the first fermentation and the second fermentation are separate processes and coupled in series, wherein the first fermentation and the second fermentation comprise different microorganisms.

Other features and advantages of the present invention will become apparent after reviewing the detailed description of the embodiments set forth below.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a typical wet mill process for alcohol production.

FIG. 2 illustrates a typical dry mill process with a backend oil recovery system.

FIG. 3 illustrates a typical dry mill process with a backend oil and protein recovery system.

FIG. 4 illustrates a typical dry mill process with a front grind milling and front oil recovery system.

FIG. 5 illustrates a typical dry mill process with a front grind milling, front oil recovery, and front de-fiber system.

FIG. 6 illustrates a typical dry mill process with a back end grind and a back end oil recovery system.

FIG. 7 illustrates a system for producing enhanced animal feed using an alcohol producing process in accordance with some embodiments.

FIGS. 8A, 8B, and 8C show results of a continuous recycling setup system in accordance with some embodiments.

FIGS. 9A, 9B, 9C and 9D show date results of a system recycling the most active yeast slurry in accordance with some embodiments.

FIG. 10 comprises a Table 2 showing results of lactic acid production by Lactobacillus brevis in different medium in accordance with some embodiments.

FIG. 11 comprises experimental results of taking a portion of the substance from the first fermentation to be added to the second fermentation as a method of growing nutrients in accordance with some embodiments.

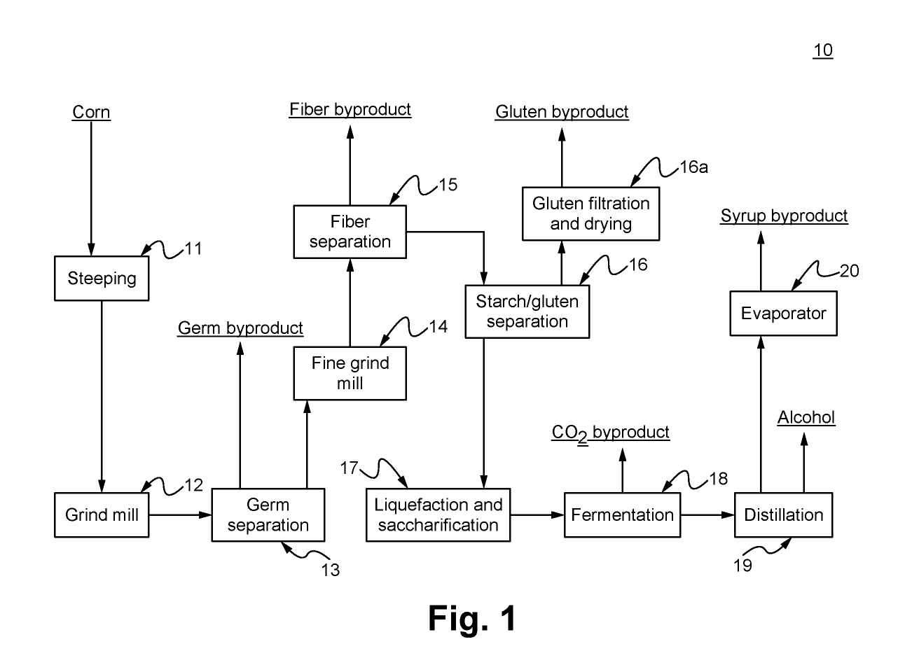

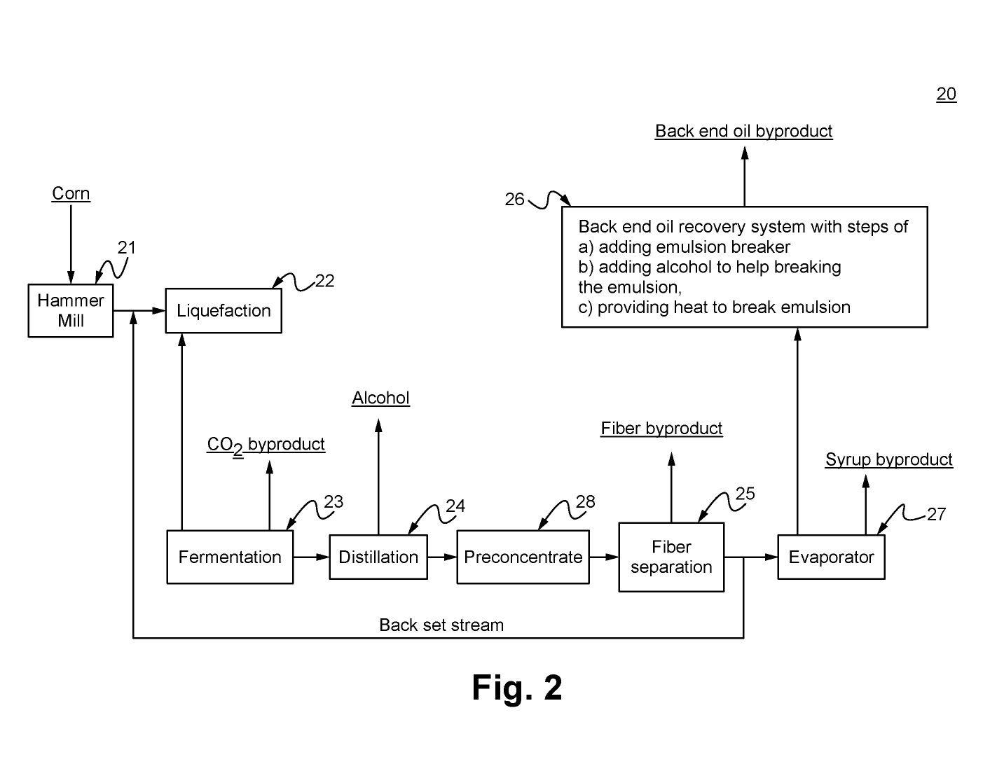

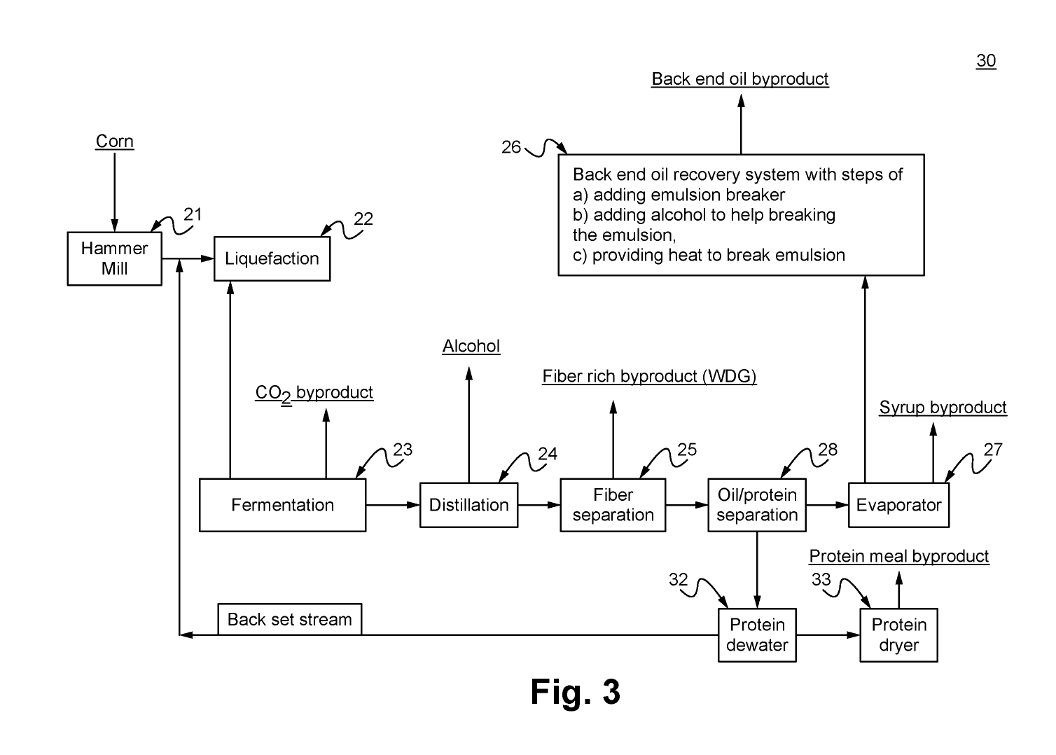

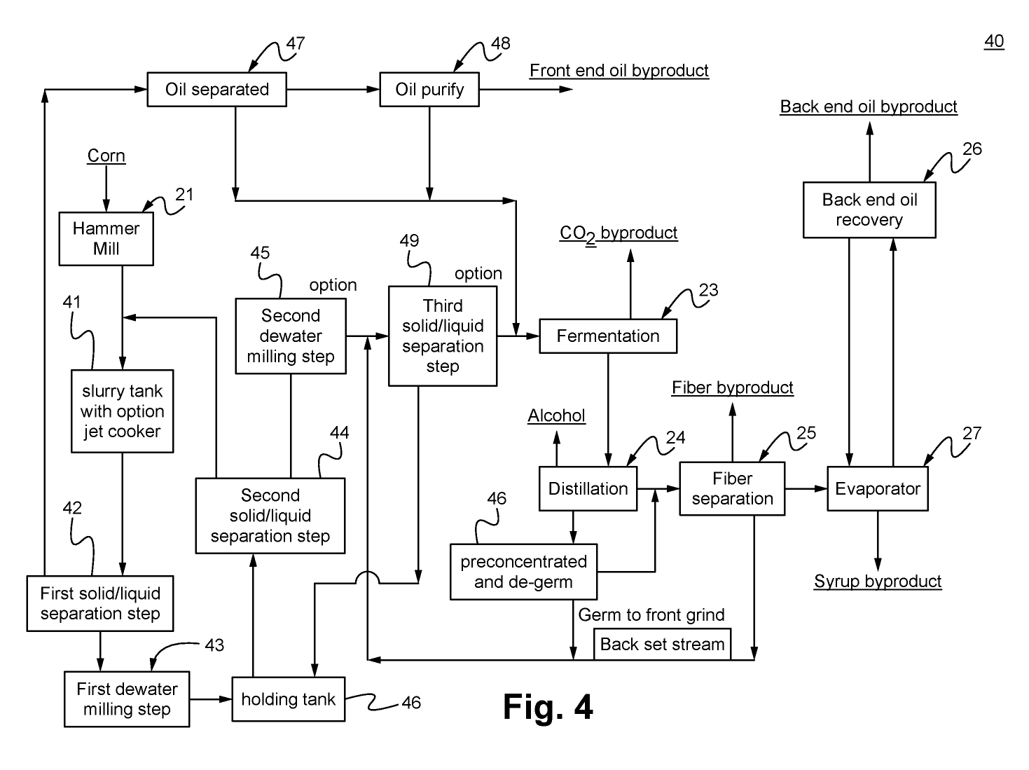

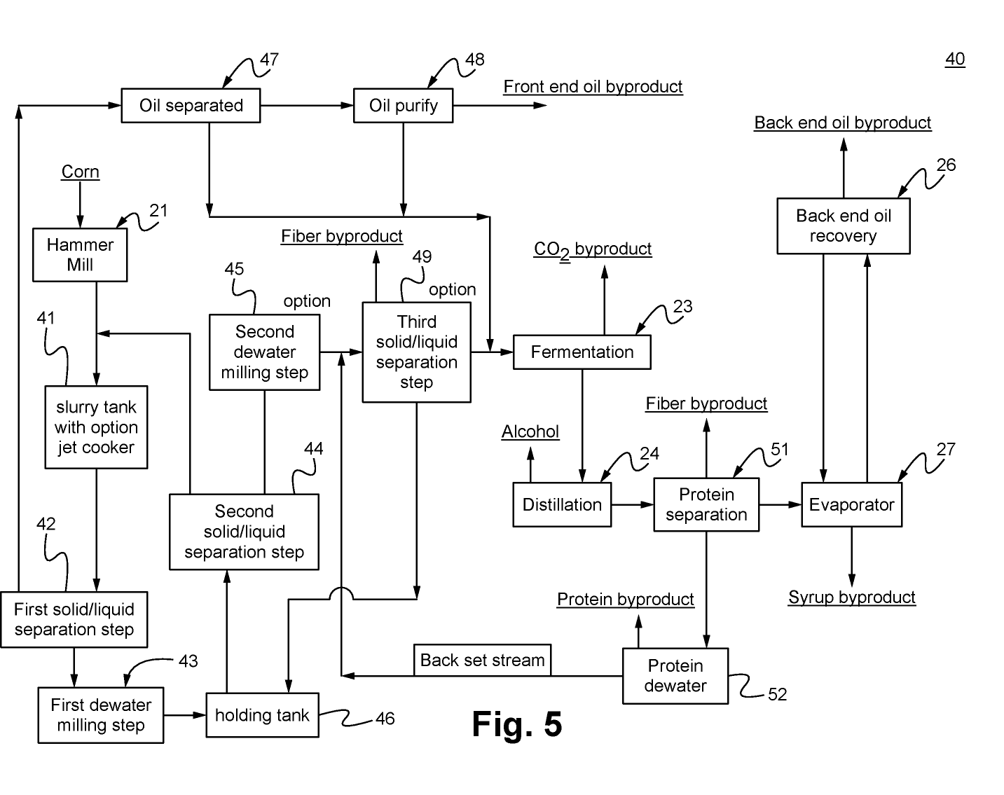

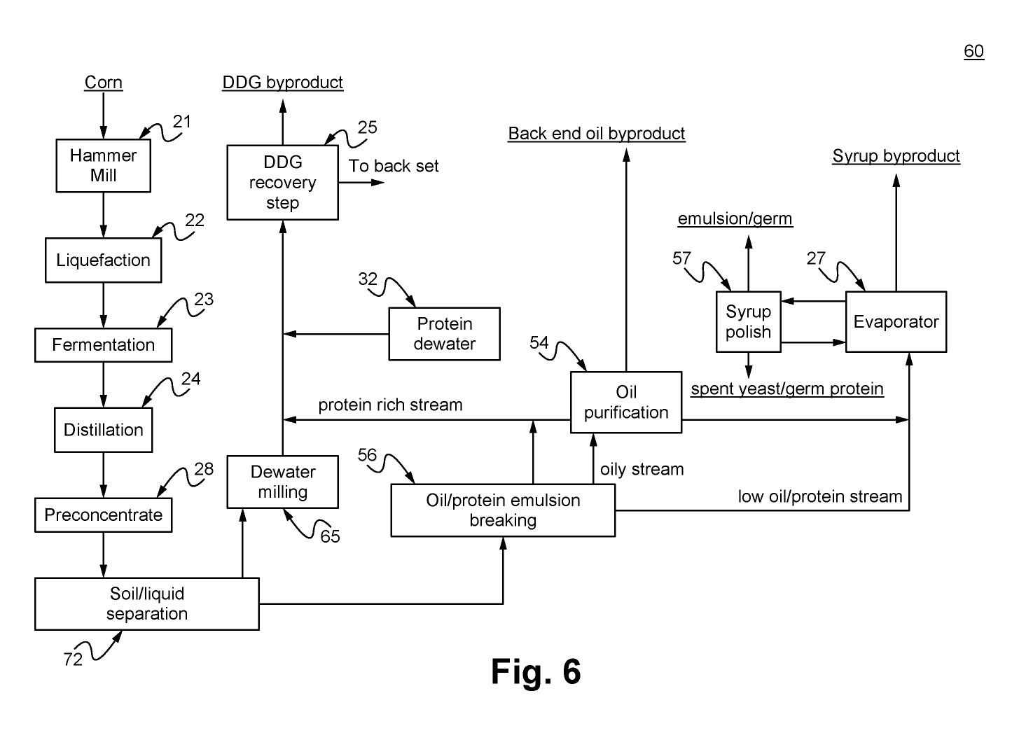

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

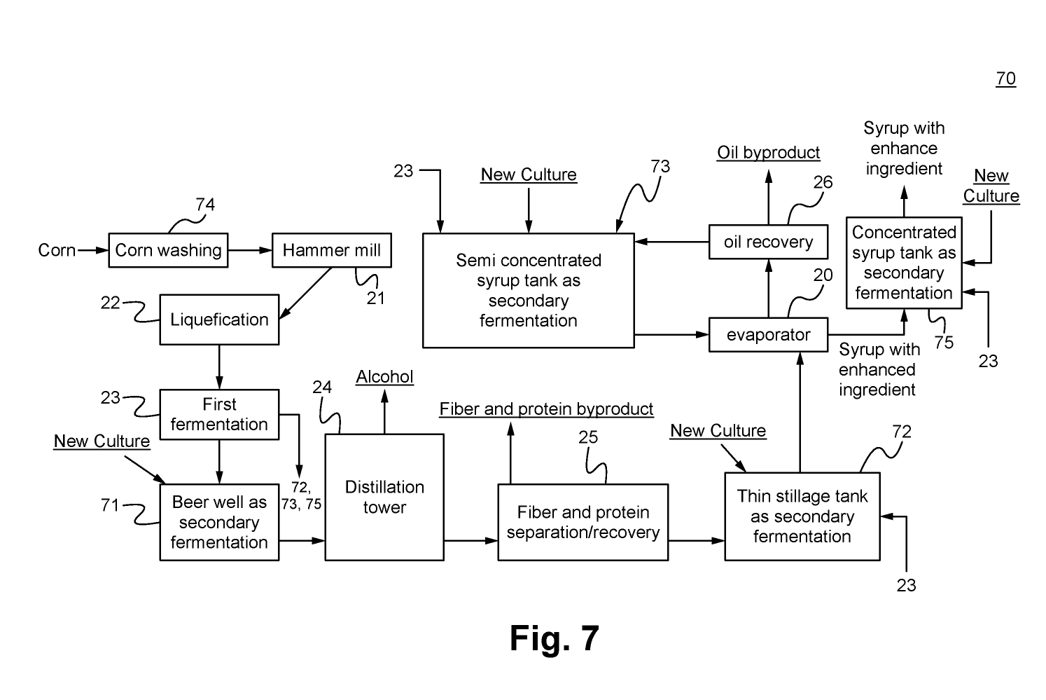

FIG. 7 illustrates an animal feed producing process 70 in accordance with some embodiments. The process 70 comprises adding microbiological substances into an alcohol production process to produce a nutrient enhanced animal feed from the soluble solid. In the process 70, grains (e.g., corns) are sent through washing 74 to remove mycotoxins before feeding the grains to a hammer mill for milling 21. In some embodiments, substantially all of the mycotoxins are removed from the surface of corns. After the milling 21 (e.g., a hammer mill), the flour devoid of mycotoxins is sent to liquefying 22, which is performed to produce a liquefied mash. The liquefied mash is then fed to fermenting 23. In some embodiments, the fermenting 23 is a fermenting process for making alcohols.

At a Step 71, the beer broth from the fermenter of fermenting 23 is fed to a large beer well as a holding tank before being processed in the distillation tower of distilling 24 to recover ethanol. The new type of culture can be added to a last stage of the fermenter tank or beer well of the fermenting 23 and use the beer well as a secondary fermentation process to produce high value feed additive ingredients, including lactic acid, carotenoids and all type of antioxidants that are used in the feed industry.

In some embodiments, a selected culture with high enough activity is used to produce the high value ingredients in the highest rate under normal fermentation conditions at drop, such as more than 12% w/v (120 g/L) alcohol, pH 4 to 5, and temperature of 85 to 90 degrees Fahrenheit. With this biological culture disclosed herein, an enhanced feed can be produced without addition of significant capital cost.

In some embodiments, the organism is added at a different step in the method 70 when the new type culture is not suitable to the above operational conditions. Conditions that would cause biological problems include the inability of the new culture to maintain sufficient activity at 12% w/v (120 g/L) of alcohol or sufficiently tolerate the fiber and protein existing in the system or thrive in the acidic environment (e.g., pH 4-5).

In some embodiments, the new culture is added to the thin stillage at a secondary fermenting 72 (after distilling 24 and centrifugal removal of fiber and protein separating/recovering 25) where primarily only soluble solids and fine suspended solids are present in the thin stillage. In some embodiments, the thin stillage tank at the secondary fermenting 72 is big enough to give sufficient holding time to produce the desired ingredients (e.g., bacteriocin and lactic acid) at the desired concentration. In some embodiments, a continually recycled culture method is used as a continuous fermentation process, which is able to cut the tank size in some degree, such as, ⅛, ⅙, ¼ or ½.

In some embodiments, the new culture is added to a semi-concentrated syrup of a secondary fermenting 73 when the new culture type has a much lower growth rate/production rate and does not like oil in the system.

In some embodiments, a secondary fermenting 75 is performed after evaporating 20 when new type of culture can grow and propagate at a higher nutrient concentration (e.g., 60% of DS) as found in the syrup after evaporator.

In some embodiments, the secondary fermentation processes, including the secondary fermenting 71, 72, and 73, make value added feed ingredients by encouraging and growing selected organisms in the same reaction vessels that the yeast use to convert glucose to ethanol.

In some embodiments, the first and the second fermentation processes are performed in the same tank or device, while the reactions conditions are able to be different for the first and second fermentations respectively.

In some embodiments, the organisms are selected and cultured based on the predetermined kinds of ingredients as animal feed additives. In some embodiments, one or more secondary fermentations occur after the completion of the primary fermentation. The secondary culture is introduced to the fermentation broth of the secondary fermenting process, such as the secondary fermenting 71, 72, and 73, and consumes non-fermentable sugars, residual fermentable sugars, other carbohydrates, amino acids, and fibers to produce a valuable metabolite. The valuable metabolite is captured in a separation process, which is used to produce the animal feed products mentioned above.

In some embodiments, the secondary fermentation produces animal feeds with selected feed additives, including one or more of lactic acids, carotenoids, antioxidants, and vitamins. The feed additives are able to be produced using the unfermented grain components in the same reaction vessel, which is able to lower the production costs significantly. In some embodiments, the selected organisms shorten the chain of long amino acids of corns, such that the sizes of the amino acids are reduced and the digestibility is increased for animals. In some embodiments, organisms and enzymes are recycled to be used.

In some embodiments, syrup is nutritional and is ideal for growing microorganisms. Probiotics, like Bacillus sp., Lactobacillus sp. and Bifidobacterium sp., help animals' immunity and digestibility. Unlike some bacteria, which can grow extremely efficient with minimal carbon supply, most probiotics need essential nutrients and elements, such as vitamins and some amino acids, in order to grow efficiently. Since syrup is a concentrate from a yeast-corn fermentation, syrup contains yeast cell debris and all essential amino acids needed by animals.

In some embodiments, corns are used as a feed source. Corns provide various vitamins and different kinds of sugar source that supports the growth of probiotics. In some embodiments, a probiotic isolate (Lactobacillus brevis strain WYC) grows very healthily and produces more than quadruple the amount of the original lactic acid and up to four fold in semi-concentrated syrup (as shown in Table 2). Accordingly in some embodiments, syrup is used as a selected environment for probiotics to grow, which makes the overall end product more beneficial to animals and more valuable as animal feed.

In some embodiments, microorganisms have aflatoxin degrading or detoxifying capabilities are used, including Pseudomonas aeruginosa, Pleurotus ostreatus, Rhodococcus erythropolis, among others. In some embodiments, test results have shown that the degradation reaction performed by these cultures is done by extracellular enzyme(s). This characteristic makes it easier for industrial application, because extracellular enzymes are usually short in peptide chain and small in size, which make it suitable to be a gene engineering tool. In some embodiments, the aflatoxin degrading enzyme is induced and excreted by selected host cells. For example, for a Bacillus thermophilus secreting amylase, the gene of amylase can be switched to aflatoxin-degrading enzyme. This modified Bacillus thermophilus is able to use the same excreting mechanism it used to excrete amylase to excrete aflatoxin-degrading enzyme, and the expression can be regulated by amylase inducer. Alternatively, the gene of aflatoxin degrading enzyme is connected after an amplifier gene on a plasmid and then inserted to a selected host.

In some embodiments during the production of syrup, corn oil and natural water soluble surfactants are heavily mixed. This mixture forms a thick layer of emulsion, which is essentially protein-coated oil droplets. Because of this emulsion, only 70% of the corn oil can be recovered near the end of the process. Emulsion is formed because of the properties of the emulsifying protein. Proteins are large molecules folded from amino acid chains. Due to different properties, different proteins have different proportion of hydrophilic and hydrophobic sides. During the mixing process, the oil droplet is formed in the water-based solution which is rich in protein. When the oil droplet makes contact with the hydrophobic part of a protein, this protein acts like a surfactant with its hydrophilic side in water-based solution and its hydrophobic side in the oil droplet. This interaction produces an oil droplet surrounded with proteins and water, which makes the droplet hard to separate from water-based solution. The separation is solely relying on density differential.

In some embodiments, emulsions which occur due to the protein emulsifiers are able to be broken by a protease action on the emulsifying proteins. Proteases are enzymes that can digest proteins into water soluble amino acid molecules. Amino acids are water soluble. By breaking proteins into amino acids, the surfactant properties of protein can be eliminated, which helps to release oil droplets from water-based solution and break emulsion. Breaking emulsion is essential to increase the recovery rate of corn oil because more droplets can be released from emulsion state and can be easily separated from water-based solution by centrifugation.

Using protease to hydrolyze proteins into amino acids can also increase digestibility when fed to animals, because amino acids are the building blocks of protein and are easier to be absorbed when compared with crude proteins. A person of ordinary skill in the art would appreciate that any source of protease can be used to achieve these goals. It can be produced by selected fermentation microorganisms, engineered microorganisms that massively produce protease, or concentrated or purified commercial protease.

In some embodiments, fermentation is done in different combination of microorganisms and/or different enzymes. These microorganisms and enzymes can be natural strains or engineered strains with enhanced abilities like stronger environmental tolerances, higher growing speed, higher enzyme production efficiency, stronger enzyme stabilities, and/or higher enzyme kinetics. In addition, microorganisms and/or enzymes can be used individually or in any combination to meet target requirements of different kinds of animals in different ages. For example, Bacillus thuringiensis can undergo co-fermentation with Monascus purpureus to produce red yeast rice for animals and minimize fly population locally at the farm at the same time. Engineered Bacillus subtilis exhibiting higher cellulase kinetics can undergo co-fermentation with engineered Lactobacillus brevis with higher lactic acid production rate to maximize conversion efficiency. Engineered protease demonstrates higher kinectics and heat resistance is added with Lactobacillus delbrueckii subsp. bulgaricus to simply break down protein to amino acids, which are more accessible for animals and maximize probiotic population for piglets.

In some embodiments, methods and devices to avoid bacterial contamination in producing animal feed are provided. In a normal batch and dry mill fermentation system, the yeast cell count during the early stage of fermentation (during the filling period) is low and the concentration of glucose is higher. During this period, there is a natural danger of bacterial contamination overtaking the yeast and producing toxic end products including lactic acid and acetic acid as well as consuming essential nutrients. This activity negatively impacts the yeast inhibiting their ability to produce desired alcohol.

In a related patent application (U.S. provisional application No. 62/044,092, which is incorporated by reference in its entirety for all purposes), the recycle of active yeast from a previously set tank to the current filling tank on batch fermentation system speeds up the fermentation rate and avoids the bacterial contamination present to outrun yeast on early stage of fermentation. In some embodiments, continuing the recycle process of the active yeast from one batch to several next batches in sequence is used, which increases the chance of slow growing bacterial contaminant to overrun the yeast.

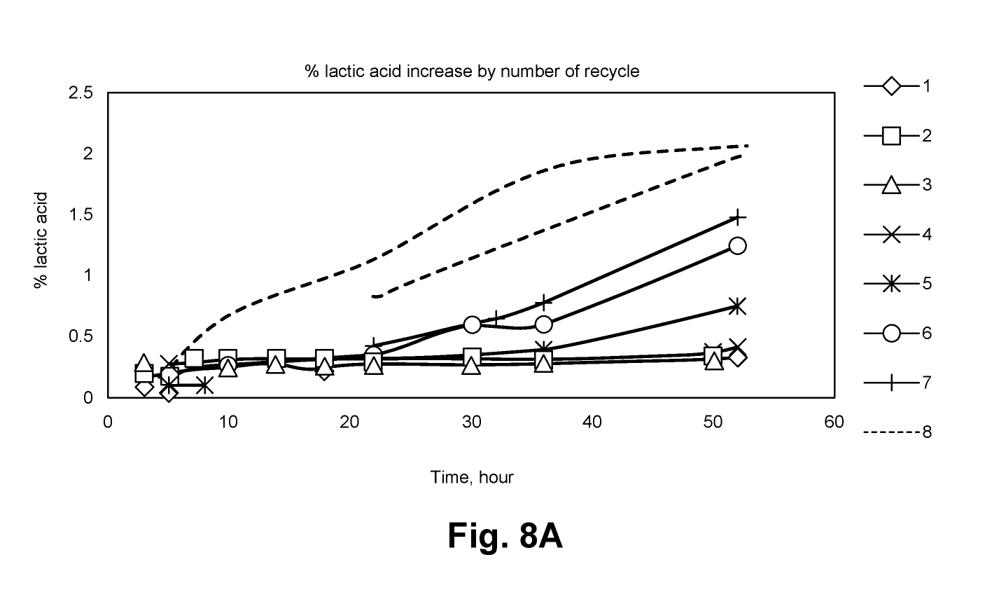

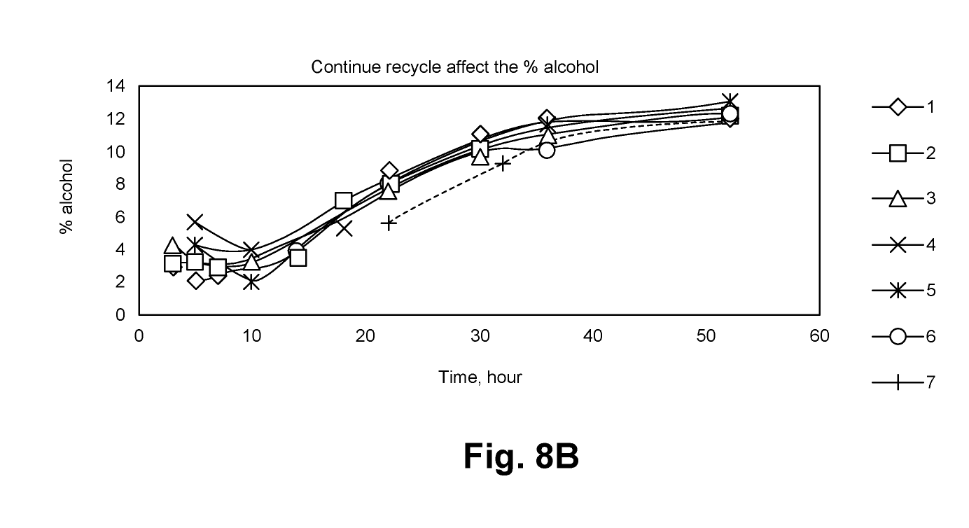

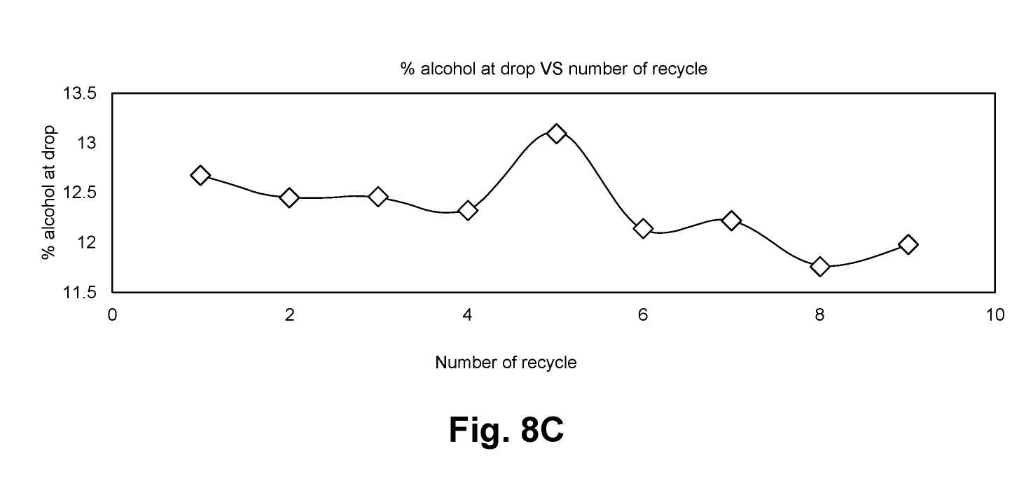

In FIG. 8A, the plot shows the % lactic acid vs. time on successive continual recycle using the system in accordance with some embodiments. The concentration of lactic acid at end of fermentation is less than 0.2% on the first and the second batch of continuous recycle system. However, the concentration of lactic acid increases with successive recycle batches to concentrations of 2% observed after 9 successive recycle batches.

FIG. 8B shows the alcohol vs. time plot with the successive recycle batches in accordance with some embodiments. This shows that the % alcohol increases with continuous recycle yeast system earlier in the fermentation batch during early and intermediate recycle batches, but the % alcohol increase rate slows down in the last few recycle batches.

FIG. 8C shows the % alcohol in drop decreases in the last several recycle batches in accordance with some embodiments.

In some embodiments, market available antibacterial and antimicrobial products are used to control bacterial infections during fermentation in the dry mill process. With the proper amount of those antibacterial or antimicrobial products added in the early fermentation stage, the undesired bacterial growth can be effectively controlled, such that a predetermined/right amount of lactic acid in the first fermentation stage at fermenter (e.g., the first fermenting 23 at FIG. 7) for alcohol production and secondary fermentation stage (e.g., the secondary fermenting 71, 72, and/or 73 at FIG. 7) for lactic acid production on beer well without loss the alcohol yields too much.

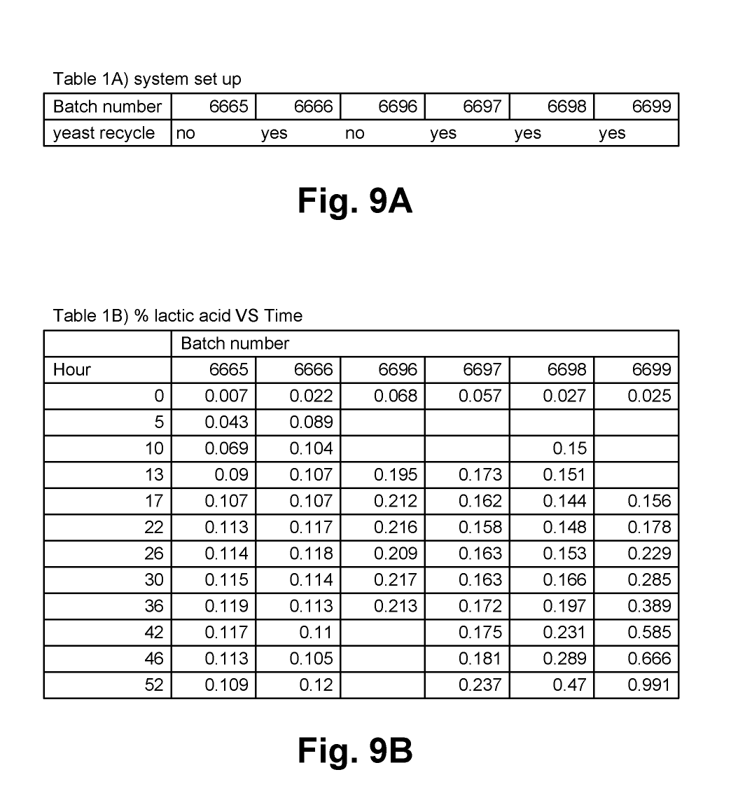

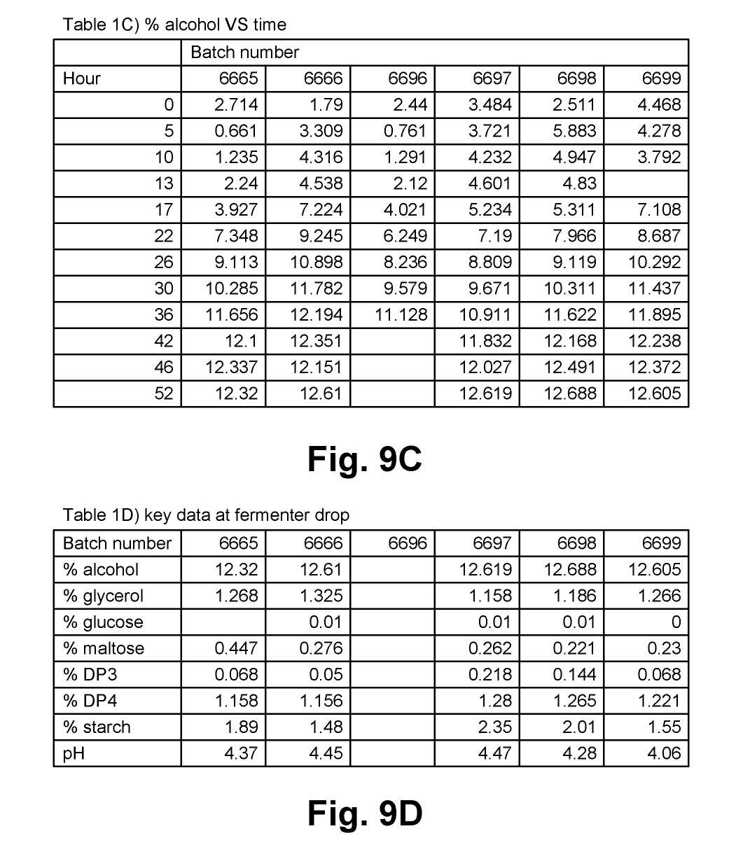

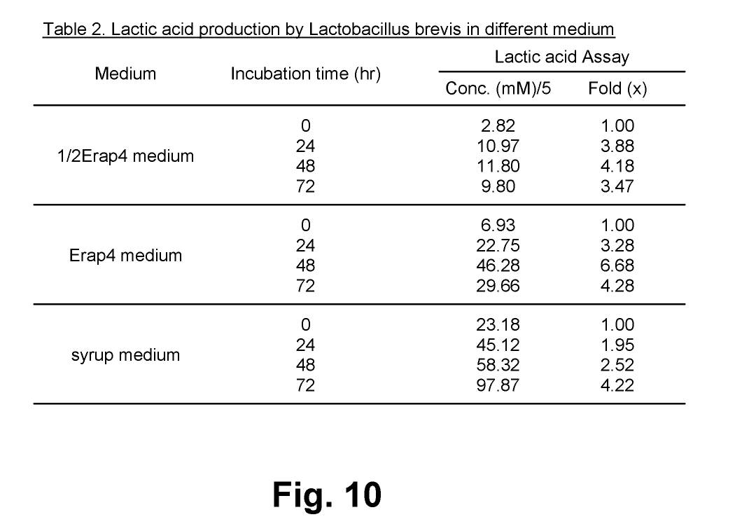

In the Tables 1A-1D (FIGS. 9A-9D) in accordance with some embodiments, a four batch continuous recycle system with 18% most active yeast transferred to the newly filling fermenter is performed. As show in the Table 1A, the batch 6696 is normally run without recycle, the batch 6697 receives 18% volume from the previous fermenter with the most active yeast from batch 6696 on first three hours of filling period on batch 6697. This recycle step is repeated for batch 6698 and 6699, 18% volume from the previous fermenter containing the most active yeast is recycled from batch 6697 to 6698 and from batch 6698 to 6699.

In the Table 1B, the % lactic acid vs. time is shown for the above four batch tests. As shown, the % lactic acid increases with time and the % lactic acid also increases with each increase in number of recycle batches.

In the Table 1C, the % alcohol vs. time is shown for this same set of batches. The alcohol increases with time, and the alcohol increases with the number of recycle batches until the last batch (batch 6699). The alcohol concentration at drop started to slow down and level off with the last few batches. The data also shows the % glucose, % maltose, %DP3, %DP4 and % glycerol over the time course for all four batches.

In the Table 1D, the experimental date at drop is shown. The data show that there is an optimum point to switch from the first fermentation mainly for alcohol production to secondary fermentation mainly for lactic acid production. In the Table 1B and 1C, it shows that the % alcohol increase rate is from 0.5% alcohol increase per hour on early hour, but the rate of increase falls to about 0.05% alcohol increase per hour at end of fermentation (at drop). The % lactic acid increase rate starts with zero during the early hours and graduate increases to about 0.04% per hour production rate at end of fermentation (at drop). Thus, it is able to be an optimized point to switch from the first fermentation stage (which produces alcohol as the primary product) to the second fermentation stage (which produced lactic acid as the primary product (on beer well or after distillation)) when the % alcohol production rate is about the same as the % of the lactic acid production rate near fermenter drop. Alternately, the predetermined amount of antimicrobial or antibiotic is added to maintain the % lactic acid in drop at around 0.4% to 0.8% to make sure the bacterial do not prematurely outrun the yeast.

In some embodiments, the optimum point to switch from the first fermentation stage to the second fermentation stage is able to be determined and affected by various factors including the types of yeasts (ability to tolerate lactic acid) and enzymes and operation conditions.

In some embodiments, the amount of antibacterial or antimicrobial is adjusted to be used in the early stage of a fermenter to control the bacterial growth and the % lactic acid present at drop to ensure that the bacteria do not take over and out run the yeast before the first (alcohol) fermentation drop. The timing of added antibacterial or antimicrobial is able to be such that the second fermentation (lactic acid production) is performed in the beer well to produce lactic acid as quickly and to as high a concentration as possible.

In some embodiments, lactic acid in beer well is produced as much as possible to optimized the reaction condition. The factors include a) setting up the beer well with a continuous fermentation system with continuous feed-in with fresh beer and continuous feed-out to achieve the maximum microorganism mass in the beer well, b) bringing the beer well level as high as possible to increase the holding time, which gives the bacterial as much time for conversion as possible in a given tank volume, c) recycling microorganism mass from the beer well to the last fermenter tank to increase the lactic acid producing microorganism mass, wherein a balance is needed to be maintained to prevent the lactic acid bacteria from out running the yeast that produces alcohol, d) other predetermined waste carbohydrate sources are added to the beer well to speed up the lactic acid production if the carbohydrate (food) for bacterial growth is the limiting factor, e) adding concentrated lactic acid producing microorganism from outside to the beer well if the microorganism mass is the limiting factor, f) adding a new type microorganism which can consume different types of carbohydrate other than glucose (such as, glycerol) that can effectively grow in the higher alcohol concentration with much faster lactic acid production.

In some embodiments, the thin stillage holding tank for the secondary fermentation stage is able to be used (secondary fermenting 72, FIG. 7) when a high alcohol concentration is the limiting factor for producing lactic acid in the beer well. Using the thin stillage holding tank as the secondary fermentation stage has the advantages of a) producing lactic acid without the inhibitory pressure of alcohol concentration; b) able to set various predetermined ideal operational conditions (pH values and temperatures) which are able to be different from the required condition for the first alcohol fermentation stage (first fermenting 23, FIG. 7); c) the high concentrated lactic acid does not recycle back to the front end through back set, since such procedure would slow the first fermentation alcohol product rate.

In some embodiments, a secondary fermentation stage (such as the secondary fermenting 75 of FIG. 7) is used in the middle of the multi stage evaporator system when the lactic acid production rate is too slow or higher lactic acid concentration is needed Taking syrup out after/at the evaporator (e.g., evaporating 20 of FIG. 7), the syrup (having intermediate concentration) produces a fermentation medium that has a much higher concentration of food, which is able to generate a higher microorganism growth rate. This higher productivity makes a relatively small secondary fermentation tank able to produce a much higher concentration lactic acid from the syrup with an intermediate concentration (e.g., half of the water is evaporated before the evaporating 20 of FIG. 7).

In some embodiments, higher concentrations of lactic acid is produced from the secondary fermentation stage in dry mill process as described above. Some other higher value chemicals or nutrients that are beneficial as feed additive in animal feed are able to be generated using other microorganisms. For example, Phaffia rhodozyma and Sporobolomyces are able to create a feed with higher concentrations of carotenoids.

In some embodiments, the method includes controlling cultured growth of high value feed organisms in a co-fermented system that produces ethanol for fuel or industrial use and allows for the culture to consume both non protein and carbohydrate based products. The methods produce products that enhance feed co-products and its associated nutritional value. The methods disclosed herein grow unique value added co-products such as mycotoxin free animal feed for the monogastric and ruminant feed markets. These markets include aquaculture, poultry, swine, companion animals, and livestock animals.

In some embodiments, the introduced culture utilizes both non-fermentable and fermentable components from processed corn and yeast metabolites. Cultures produce valuable metabolites which are further processed using typical equipment and are incorporated into the co-product feeds being produced at the facility. These designer feeds are enhanced by the metabolites of the culture and yeast and have higher digestibility and unique nutritional value.

In some embodiments, the systems and methods culture a continuous inoculum in a controlled manner. The system utilizes a reactor that is constantly receiving fresh feedstock, specifically the beer well, which supports the growing culture. Next, the system is used to seed the batch fermentation vessels after fermentable sugars, which are utilized to make ethanol. The vessels (existing fermenters) are inoculated with culture from the continuous beer well reactor at a specific time and inoculum rate. The cultured organisms and traditional Saccharomyces cerevisiae are co-fermented in a shared reactor for a predetermined amount of time and then are transferred to the continuous reactor (the beer well) to make space for a new batch. This serves as a way to enhance the co-fermentation rate and productivity, which also provides culture for the next batch in the sequence.

In some embodiments, the method includes the ability to change the culture at any time depending on market conditions and feed specifications. Enhanced feed products include one or more of the nutrients including lactic acid, antioxidants, carotenoids, and amino acids. The above mentioned nutrients are highly digestible and desirable in animal feed. In some embodiments, the method is able to fortify animal feeds by removing mycotoxins and co-fermenting biological organisms to produce animal feed with a higher value.

### Experiments

### EXAMPLE 1

An isolate of lactic acid bacteria is introduced to the syrup tank. A fermentation process takes place allowing this isolate to replicate in the syrup and consume hydrocarbon as a carbon source and produce lactic acid as metabolites under predetermined conditions. The end product contains a high level (4 times higher than starting) of both lactic acid and lactic acid bacteria, as well as the essential nutrients which existed in untreated syrup.

### EXAMPLE 2

The isolate is introduced to the thin stillage tank prior to concentration to deplete hydrocarbon and produce lactic acid. The isolate is killed by heat in the evaporation concentration process to produce syrup. As a concentrated nutrition-rich liquid, the syrup is used as a medium like probiotic booster to incubate probiotics selected by livestock producers. During use, the syrup is diluted to increase the population of probiotics and enhance the activity of probiotics.

### EXAMPLE 3

The isolate is introduced to the thin stillage tank prior to concentration to deplete hydrocarbon and produce lactic acid. The isolate is killed by heat in the concentration process to produce syrup. Selected probiotics are introduced into syrup according to what animal is predetermined to be fed. The syrup with probiotics is held under optimal storage conditions to keep probiotics alive but without forcing active growth. As the product reached users, users are able to add a predetermined ratio of water to dilute syrup and reactivate the bacterial probiotics. The diluted syrup with probiotics are able to be stored for a short period allowing probiotics to replicate to desired concentration to maximize performance.

### EXAMPLE 4

A beneficial microorganism isolate, namely probiotics, is introduced directly to syrup and consumes all consumable hydrocarbons to generate lactic acid while propagating. After the propagation reached saturation and lactic acid reached maximum conversion, probiotics enter a living-but-not-growing state (stationary phase), and the ferment is able to be sold directly as lactic acid and probiotics enhanced animal additive, or as a liquid probiotic culture for plant waste treatment.

### EXAMPLE 5

After syrup fermentation, the ferment is able to be separated into liquid part of the ferment and the mud-like highly concentrated insoluble solids, including probiotics. The mud-like material can be sold as a concentrated probiotic culture paste or can add excipients to make probiotic powder for animal feed additive and plant waste treatment. The liquid part of the ferment separated from syrup can be sold as lactic acid enriched animal feed additive or goes through further concentration process to produce concentrated lactic acid enriched animal feed additive.

### EXAMPLE 6

Syrup further goes through a concentration process to produce a concentrated syrup. A beneficial bacterial isolate that has specific function to animal feed is introduced into the concentrated syrup to grow the bacterial to a stationary phase. The product is function enhanced nutritional animal feed. The product is able to be sold as is or is further processed and sold as a concentrate for animal feed additive.

### EXAMPLE 7

Probiotics that produce lactic acid are added into concentrated syrup to produce lactic acid while replicating. After reaching stationary phase and maximum conversion rate, the product is lactic acid and probiotic enriched animal feed additive. The product is sold as is or is further processed as regular syrup ferment previously described.

### EXAMPLE 8

Proteases is added prior to or after secondary fermentation to further break emulsion and increase the recovery rate of corn oil. Proteases break proteins into small molecules, eliminate the hydrophobic and hydrophilic properties of proteins, and therefore, releases oil droplets from an emulsion state. Completing this step increases the weight percentage of lactic acid and also increases the density of living beneficial microorganisms in syrup, which is able to be sold as concentrated animal feed additive.

### EXAMPLE 9

The culture source for the secondary fermentation process is taken from the end of the First fermentation 23 (a process for alcohol production) of FIG. 7. A 25% volume (100 mL) of the material from the end of the first fermentation process is added to 75% volume (300 mL) of semi-concentrated syrup that has been cooled to 90 degrees Fahrenheit or colder. The syrup is adjusted to pH 6 with caustic soda to allow the microorganism to grow on glucose, maltose and residual starch. The mixture is incubated at 90 degrees Fahrenheit for 5 days. During the incubation the lactic acid concentration increases by more than 4 times as the microorganism grew. This shows that mixing a volume of fermented material from the first fermentation is able to be added to a volume of cooled and pH adjusted semi-concentrated syrup or concentrated syrup to produce lactic acid as show the secondary fermenting 73 and 75 of FIG. 7.

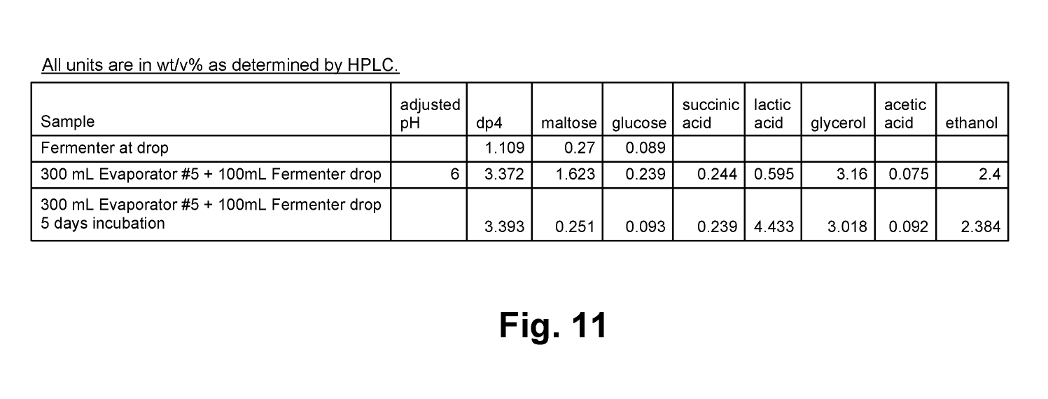

FIG. 11 comprises experimental results of Example 9, which takes a portion of the substance from the first fermentation to be added to the second fermentation as a method of growing nutrients, in accordance with some embodiments.

In some embodiments, the nutrient enhancing process disclosed herein applies to other fields that produce organic wastes, which is able to be used to produce high-value animal feed ingredients. For example, vast amount of vegetable waste is produced from vegetable farms each year. These vegetables waste contain cellulose, hemicellulose, starch, sugars, proteins, vitamins, antioxidants and essential elements. Cellulose and hemicellulose are able to be degraded to monosaccharides to grow probiotics and produce organic acids. The rest of them are readily available nutrients for animals and are more accessible after the proper processing procedures.

The embodiments described herein provide a method to remove mycotoxins from the corn grain prior to processing, which reduces the concentration of the mycotoxins in the animal feeds that are produced at a corn based ethanol plant. The mycotoxin free animal feeds produced using the process disclosed herein are able to be used to feed animals without concerns of the negative health effects associated with mycotoxins. Furthermore, the process described herein produces a low insoluble, low fiber, and nutritive soluble stream that is suitable for feeding young animals. This soluble stream contains a mixture of corn and yeast components that have high digestibility and perfectly suited for baby animals. This stream contains a mixture of amino acids, minerals and yeast components that provide a feed containing growth factors. The soluble stream can be concentrated to have about 80% solids, which increases a shelf life by limiting the growth of organisms at this stage and lowers transportation costs throughout the world. In some embodiments, baby swine and aquaculture feeding systems are able to use this highly nutritive soluble stream with the growth factors to enhance a weight gain and facilitate the growth of the aquatic fish and algae. The algae becomes an excellent feed in itself for the larger organisms in the aquaculture system, namely fish, crustaceans, and shrimp. The algae growth contains proteins, fibers, fats and minerals that can enhance the entire ecosystem of the aquaculture.

In some embodiments, the term “culture” used herein refers to the cultivation of bacteria and/or tissue cells in an artificial medium containing nutrients. In some embodiments, the term “culture” used herein refers to maintaining (tissue cells, bacteria, etc.) in conditions suitable for growth. In some embodiments, the term “culture” used herein refers to the microorganisms, such as yeast.

In some embodiments, the method includes the production of organic acids to enrich animal feed for an enhanced animal performance with reduced/avoided antibiotic components in the feed. The method includes the production and incorporation of probiotics in the animal feed product.

In utilization, the methods and systems of the present invention can produce nutrient value enhanced animal food. The nutrients include lactic acid, antioxidants, carotenoids, and amino acids that are highly digestible and desirable in animal feed. Further, the method and system disclosed herein are able to be used to fortify animal feeds by removing mycotoxins.

In operation, corns as feedstock are washed, liquefied, and fermented the first time. In some embodiments, new cultures are added to a second fermenting tank as a secondary fermentation. In some embodiments, the second fermentation is at 1) the beer well between the first fermenting and the distilling, 2) thin stillage tank after the distilling and fiber/ protein separating, 3) semi-concentrated syrup tank after holding tank of the thin stillage, 4) syrup after evaporator, and/or 5) concentrate syrup.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims.

What is claimed is:

1. A method of producing a nutrient added animal feed comprising:
a. performing a first fermentation; and
b. generating an organic acid, probiotics, antioxidants, carotenoids, amino acids or a combination thereof in a second fermentation.

2. The method of claim 1, further comprising adding microorganisms to the second fermentation.

3. The method of claim 1, wherein the microorganisms comprise Lactobacillus spp., Bifidobacterium spp., Streptococcus spp., or a combination thereof.

4. The method of claim 1, wherein the microorganisms comprise Bacillus spp., Enterococcus spp., or a combination thereof.

5. The method of claim 1, wherein the microorganisms produces proteases breaking emulsion to improve oil recovery.

6. The method of claim 5, wherein the microorganisms comprise Bacillus fastidiosus, Aspergillus funiculosus, or a combination thereof.

7. The method of claim 1, further comprising providing an environment suitable for a growth of probiotic microorganisms.

8. The method of claim 1, wherein the organic acid comprises lactic acid or acetic acid.

9. The method of claim 1, further comprising growing probiotics using a liquid ferment from the first fermentation as a culture.

10. The method of claim 1, wherein the first fermentation is performed in series before the second fermentation, wherein the first fermentation comprises a first of microorganism different from a second microorganism in the second fermentation.

11. A method of producing a nutrient added animal feed comprising:
a. performing a first fermentation;
b. adding microorganisms to a second fermentation; and
c. producing probiotic animal feed.

12. The method of claim 11, wherein the first fermentation comprises a fermentation step for alcohol production.

13. The method of claim 11, wherein the second fermentation is at a beer well.

14. The method of claim 13, wherein the beer well is after the first fermentation and before distilling.

15. The method of claim 11, wherein the second fermentation is at a thin stillage.

16. The method of claim 15, wherein the thin stillage is after separating fiber and protein.

17. The method of claim 11, wherein the second fermentation is at a whole stillage after distilling.

18. The method of claim 11, wherein the second fermentation is at a concentrated or semi-concentrated syrup tank.

19. The method of claim 11, wherein the second fermentation is performed during a multi-stage evaporating.

20. The method of claim 11, wherein the second fermentation is before oil separating.

21. The method of claim 11, wherein the second fermentation is after oil separating.

22. The method of claim 11, wherein the second fermentation is after evaporating.

23. The method of claim 11, wherein the second fermentation comprises protein, fat, minerals, amino acid, yeast metabolites, fiber, monosaccharides, disaccharides, oligosaccharides, potassium, phosphorus, or unidentified growth factors.

24. A system for making probiotic animal feed comprising:
a. a first fermenter for making alcohol; and
b. a second fermenter with added microorganisms coupled with the first fermenter.

25. The system of claim 24, wherein the second fermenter is at a beer well.

26. The system of claim 25, wherein the beer well is after the first fermenter and before distiller.

27. The system of claim 24, wherein the second fermenter is at a thin stillage tank.

28. The system of claim 27, wherein the thin stillage is after a fiber and protein recovery device.

29. The system of claim 24, wherein the second fermenter comprises a whole stillage after a distilling device.

30. The system of claim 24, wherein the second fermenter is at a concentrated syrup or semi-concentrated syrup tank.

31. The system of claim 24, wherein the second fermenter is before an oil recovering device.

32. The system of claim 24, wherein the second fermenter is after an oil recovering device.

33. The system of claim 24, wherein the second fermentation is after evaporator.

34. A method of producing a nutrient added animal feed comprising:
a. removing aflatoxins from incoming corn with a water wash system before a hammer mill;
b. performing a first fermentation; and
c. generating probiotics, antioxidants, carotenoids, amino acids or a combination thereof in a second fermentation.

35. The method of claim 34, further comprising adding microorganisms to the second fermentation.

36. The method of claim 34, wherein the microorganisms comprise Bifidobacterium spp., Streptococcus spp., Bacillus spp., or a combination thereof.

37. The method of claim 34, wherein the microorganisms comprise Bacillus spp., Enterococcus spp., or a combination thereof.

38. The method of claim 34, wherein the microorganisms produces proteases breaking emulsion to improve oil recovery.

39. The method of claim 38, wherein the microorganisms comprise Bacillus fastidiosus, Aspergillus funiculosus, or a combination thereof.

40. The method of claim 34, further comprising providing an environment suitable for a growth of probiotic microorganisms.

41. The method of claim 34, wherein the organic acid comprises lactic acid or acetic acid.

42. The method of claim 34, further comprising growing probiotics using a liquid ferment from the first fermentation as a culture.

43. A system for making probiotic animal feed with low aflatoxin concentration comprising:
a. washing aflatoxins out of incoming corn with a water wash system before the hammer mill;
b. a first fermenter for making alcohol; and
c. a second fermenter with added microorganisms coupled with the first fermenter.

44. The system of claim 43, wherein the second fermenter is at a beer well.

45. The system of claim 44, wherein the beer well is after the first fermenter and before distillation.

46. The system of claim 43, wherein the second fermenter is performed in the thin stillage tank.

47. The system of claim 46, wherein the thin stillage is after a fiber and protein recovery device.

48. The system of claim 43, wherein the second fermenter system comprises fermenting after distillation.

49. The system of claim 43, wherein the second fermenter is at a concentrated syrup or semi-concentrated syrup tank.

50. The system of claim 43, wherein the second fermenter is before an oil recovering device.

51. The system of claim 43, wherein the second fermenter is after an oil recovering device.

52. The system of claim 43, wherein the second fermentation is after evaporation.

53. A method of producing a nutrient added animal feed comprising:
a. performing a first fermentation for producing an alcohol;
b. taking microorganisms at an end of first fermentation; and
c. adding the microorganisms in a second fermentation after distillation to propagate and produce organic acid, probiotic or a combination thereof

54. The method of claim 53, wherein the second fermentation comprises a fermenter having a whole stillage tank after a distilling device.

55. The method of claim 53, wherein the second fermentation comprises a fermenter having a thin stillage tank after separating fiber and protein.

56. The method of claim 53, wherein the second fermentation comprises a fermenter having a semi-concentrate syrup tank during a process of multi stage evaporating.

57. The method of claim 53, wherein the second fermentation comprises a fermenter having a syrup tank after evaporating.

58. The method of claim 53, further comprising adding the microorganisms as a culture to the second fermentation.

59. The method of claim 53, further comprising providing an environment suitable for a growth of probiotic microorganisms.

60. The method of claim 53, further comprising providing an environment suitable for a growth of a type of microorganism, which breaks down a mycotoxin in the secondary fermentation.

61. The method of claim 1, wherein the first fermentation and the second fermentation are separate processes and coupled in series, wherein the first fermentation and the second fermentation comprise different microorganisms.
